(19) United States
(12) Patent Application Publication
(10) Pub. No.: US 2010/0332395 A1
(43) Pub. Date: Dec. 30, 2010

(54) COMPUTER-IMPLEMENTED METHODS OF OPERATING A KEYING AND BALANCING WORKSTATION OF AN IMAGE-BASED CHECK PROCESSING SYSTEM

(76) Inventor: David Gregg Simmons, Waterloo (CA)

Correspondence Address: PAUL W. MARTIN, NCR CORPORATION, LAW DEPT., 3097 SATELLITE BLVD., 2nd FLOOR, DULUTH, GA, 30096, US

(21) Appl. No.: 12/491,727

(22) Filed: Jun. 25, 2009

(51) Int. Cl. G06Q 40/00; G06F 17/30; G06F 17/40; G06K 9/00

(52) U.S. Cl. 705/45; 382/137; 707/770

(57) ABSTRACT

A computer-implemented method of operating a keying and balancing workstation of an image-based check processing system is provided. The computer-implemented method comprises obtaining a free check item from a list of free check items, extracting payee information from the free check item, establishing a payee name from the extracted payee information, obtaining an account number from a deposit slip, obtaining a list of depositor names based upon the account number obtained from the deposit slip, comparing the payee name with depositor names contained in the list of depositor names to determine if the payee name matches a depositor name, and associating the free check item with the depositor slip when the payee name matches a depositor name from the list of depositor names.

### BACKGROUND

The present invention relates to balancing out-of-proof deposit transactions at a keying and balancing workstation of an image-based check processing system, and is particularly directed to computer-implemented methods of operating a keying and balancing workstation of an image-based check processing system.

A typical image-based check processing system includes a check processing transport which has a document track and a number of check processing modules positioned along the document track for performing specific document processing operations on document items including checks and deposit slips moving downstream along the document track. A transport processor executes a transport application program which is stored in memory to control operation of devices contained within the check processing modules positioned along the document track and thereby to control operation of the check processing transport.

A typical check processing transport includes a hopper into which a stack of document items is placed. An operator initially prepares the document items (e.g., orienting document items properly (forwards and right-side up), removing staples, removing paper clips, straightening bent corners, and the like) before they are placed into the hopper. A document feeder adjacent the hopper selectively feeds or drives each document item from the stack of document items in the hopper to transport the document item from the upstream end to the downstream end along the document track past an image capture device and a magnetic ink character recognition (MICR) reader. The image capture device captures an image of the front of the document item and an image of the back of the document item. The MICR reader reads a codeline from each document item. The document items are eventually transported to sorting pockets of a pocket device located at the downstream end of the document track. The pockets receive document items which have been sorted based upon the particular transport application program.

In known image-based check processing systems, operators working at a keying and balancing workstation perform the functions of amount keying, codeline completion, balancing, and expert balancing to balance out-of-proof deposit transactions. Each deposit transaction includes a number of debit items and a number of credit items. Total amount of the debit items is intended to equal total amount of the credit items. When total amounts are not equal, the particular deposit transaction does not balance and an out-of-proof deposit transaction exists. To balance an out-of-proof deposit transaction, a transaction item (debit item or credit item) causing the out-of-proof condition must be identified and then corrected.

From time to time, a check item is identified as not belonging to the deposit transaction currently being processed. These check items are known as “free items”, and eventually need to be associated with the correct deposit transaction. When an item is identified as being a free item, the item is moved to a free item list. Whenever a balance operator is presented with a new out-of-proof deposit transaction, the operator manually looks at free items contained in the free item list in attempt to balance the out-of-proof deposit transaction. A drawback in using the free item list in this manner is that it is relatively time-consuming for the operator to look at each of the free items contained in the free item list while attempting to balance the out-of-proof deposit transaction.

### SUMMARY

In accordance with one embodiment of the present invention, a computer-implemented method of operating a keying and balancing workstation of an image-based check processing system is provided. The computer-implemented method comprises obtaining a free check item from a list of free check items, extracting payee information from the free check item, establishing a payee name from the extracted payee information, obtaining an account number from a deposit slip, obtaining a list of depositor names based upon the account number obtained from the deposit slip, comparing the payee name with depositor names contained in the list of depositor names to determine if the payee name matches a depositor name, and associating the free check item with the depositor slip when the payee name matches a depositor name from the list of depositor names.

### BRIEF DESCRIPTION OF THE DRAWINGS

In the accompanying drawings:

FIG. 1 is a schematic block representation of an image-based check processing system in accordance with one embodiment of the present invention;

FIG. 2 is an enlarged detailed schematic block representation of a keying and balancing workstation of the image-based check processing system of FIG. 1;

FIG. 3 is a flowchart depicting a process associated with the keying and balancing workstation of FIG. 2 and in accordance with one embodiment of the present invention; and

FIGS. 4-6 are flowcharts depicting other processes associated with the keying and balancing workstation of FIG. 2 and in accordance with different embodiments of the present invention.

### DETAILED DESCRIPTION

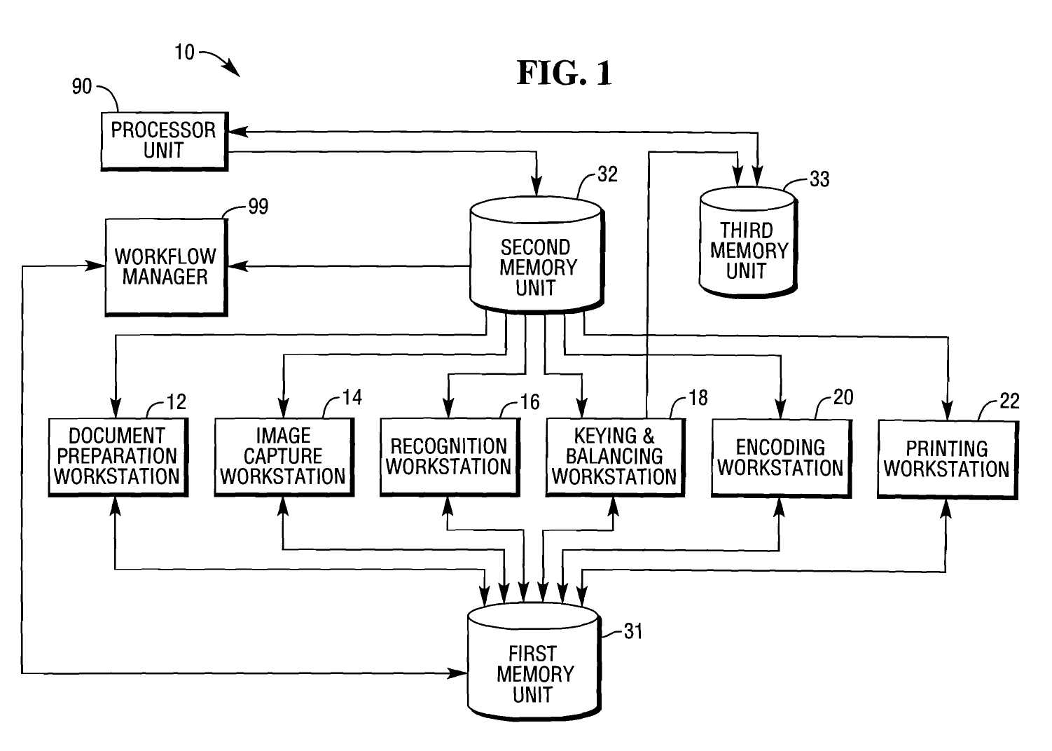

The present invention is particularly directed to computer-implemented methods of operating a keying and balancing workstation of an image-based check processing system. An image-based check processing system 10 in accordance with one embodiment of the present invention is illustrated in FIG. 1. The image-based check processing system 10 comprises different types of workstations including a document preparation workstation 12, an image capture workstation 14, a recognition workstation 16, a keying and balancing workstation 18, an encoding workstation 20, and a printing workstation 22. Each of the workstations 12, 14 creates units of work and submits the created work to a workflow manager 99 in a known way. Each of the workstations 16, 18, 20, 22 polls the workflow manager 99 in a known manner for work to perform, and may also create units of work which is submitted back to the workflow manager 99.

At the document preparation workstation 12, transaction items including a number of debit items and a number of credit items associated with each transaction are prepared for further processing. Preparation of the debit and credit items may include removal of paper clips, staples, and the like, and stacking of the items in a particular order and/or direction in suitable trays. The trays containing the stacked items are then manually carted to the image capture workstation 14.

At the image capture workstation 14, the stacked items in the trays are manually removed from the trays and placed onto an image lift transport (not shown) of the image capture workstation 14. The transaction items on the image lift transport are moved along a path in front of a front image lift camera and in front of a rear image lift camera (both not shown). The image lift camera optically scans each item as the item moves along the path in front of the cameras to produce front and rear electronic images of the item. The electronic images of the item are then stored in a first memory unit 31. An image database containing electronic images of the transaction items including the debit items and the credit items is thereby created and stored in the first memory unit 31. Also, if the item being processed contains a magnetic ink character recognition (MICR) codeline, the MICR codelines is read as the item passes by a MICR reader (not shown). The MICR codeline is associated with the front and rear electronic images and then stored in the image database in the first memory unit 31.

After the electronic images of an item are lifted by the image lift cameras and the images and MICR codeline are captured, the item is then sorted into an appropriate sorter pocket (not shown) of the image capture workstation 14. The image capture workstation 14 may comprise the Model 7780 Item Processing System, manufactured by NCR Corporation, located in Dayton, Ohio. The sorted items in each of the sorter pockets are then stacked in a respective tray. The trays are then manually carted to the encoder workstation 20. The trays of items await at the encoder workstation 20 until the electronic images and the MICR codelines of the items which were earlier captured and stored in the first memory unit 31 at the image capture workstation 14 are processed by the recognition workstation 16 and the keying and balancing workstation 18 in the manner described hereinbelow.

At the recognition workstation 16, the electronic images of the items stored in the image database in the first memory unit 31 after being processed at the image capture workstation 14 are processed using known recognition techniques to determine the “amount” associated with each item. The amount of each item is then associated with the corresponding electronic images and the MICR codeline of the item and stored in the database in the first memory unit 31. A one-to-one correspondence is thereby established between the electronic images and the MICR codeline of each item and the amount associated with that particular item to provide the image database in the first memory unit 31 as previously described.

It should be noted that some amounts will not be recognizable to the recognition workstation 16. Also, some amounts recognized at the recognition workstation 16 may have a low confidence level associated therewith. These items are identified and then processed further at the keying and balancing workstation 18.

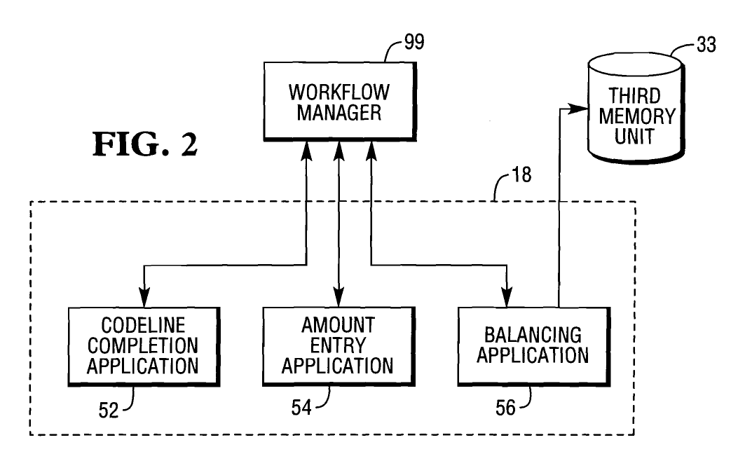

As shown in FIG. 2, the keying and balancing workstation 18 comprises a number of applications including a codeline completion application 52, an amount entry application 54, and a balancing application 56. Each of the applications 52, 54, 56 communicates with the workflow manager 99 and receives units of work to process from the workflow manager 99 in response to units of work being completed by the recognition workstation 16. Each of the applications 52, 54, 56 also communicates with a second memory unit 32 (shown only in FIG. 1), and the balancing application 56 communicates with a third memory unit 33. The second memory unit 32 is a database which stores a list of depositor names to be described in more detail later. The third memory unit 33 is a database which stores a list of free items also to be described in detail later.

An operator at the keying and balancing workstation 18 has a multiple number of applications from which to select. The operator may select the codeline completion application 52 from an application selection menu (not shown) which enables the operator to manually complete the MICR codeline which identifies the particular transaction document item. More specifically, the workflow manager 99 establishes, in a known way, any items with either missing or rejected MICR-related information. These items are displayed on a display screen of a monitor at the keying and balancing workstation 18. The operator at the keying and balancing workstation 18 completes the codelines of the items identified as having either missing or rejected MICR-related information.

An operator at the keying and balancing workstation 18 may also select the amount entry application 54 from the application selection menu which enables the operator to manually complete the amount of the debit items and the credit items, as the case may be. More specifically, after the MICR codelines of all of the items have completed, the workflow manager 99 establishes, in a known way, any items with either missing, rejected, or low confidence amount information from the recognition workstation 16. These items are displayed on the display screen of the monitor at the keying and balancing workstation 18. The operator at the keying and balancing workstation 18 completes the amount field of the items identified as having missing, rejected, or low confidence amounts.

An operator at the keying and balancing workstation 18 may also select the balancing application 56 from the application selection menu which enables the operator to balance out-of-proof transactions. More specifically, after the amount fields of all of the items have been completed, the workflow manager 99 establishes, in a known way, any batches of items containing transactions which are out-of-proof.

It is contemplated that more than one operator may be dedicated to the function of completing codelines of items at the keying and balancing workstation 18. Also, more than one operator may be dedicated to the function of completing the amount fields of items at the keying and balancing workstation 18. Similarly, more than one operator may be dedicated to the function of balancing batches of items at the keying and balancing workstation 18.

Although the foregoing describes a “batch” containing multiple transactions, it is contemplated that a “block” containing multiple batches may be processed in the same manner. A block or a batch containing multiple transactions may sometimes be referred to as a “unit of work”.

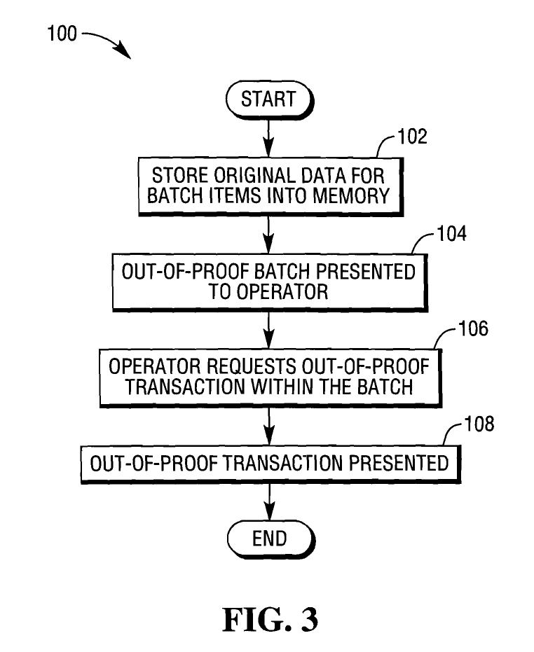

When at least one out-of-proof transaction is determined to exist, the entire batch of transactions is processed further at the keying and balancing workstation 18 as described in detail hereinbelow with reference to a flowchart 100 illustrated in FIG. 3. The flowchart 100 depicts the process followed by the operator in balancing the batch which includes at least one out-of-proof transaction. In step 102, the original data for each item in the batch of transaction items is stored into the first memory unit 31 for later analysis. The original data includes data such as original amounts, item types, and adjustment flags for each item in the out-of-proof batch of transactions. In step 104, the batch of transactions containing the at least one out-of-proof transaction is presented to the operator via the display screen of the monitor at the keying and balancing workstation 18. The operator then presses an appropriate key at the keying and balancing workstation 18 to request that an out-of-proof transaction be located, as shown in step 106. In step 108, one unbalanced transaction is displayed to the operator.

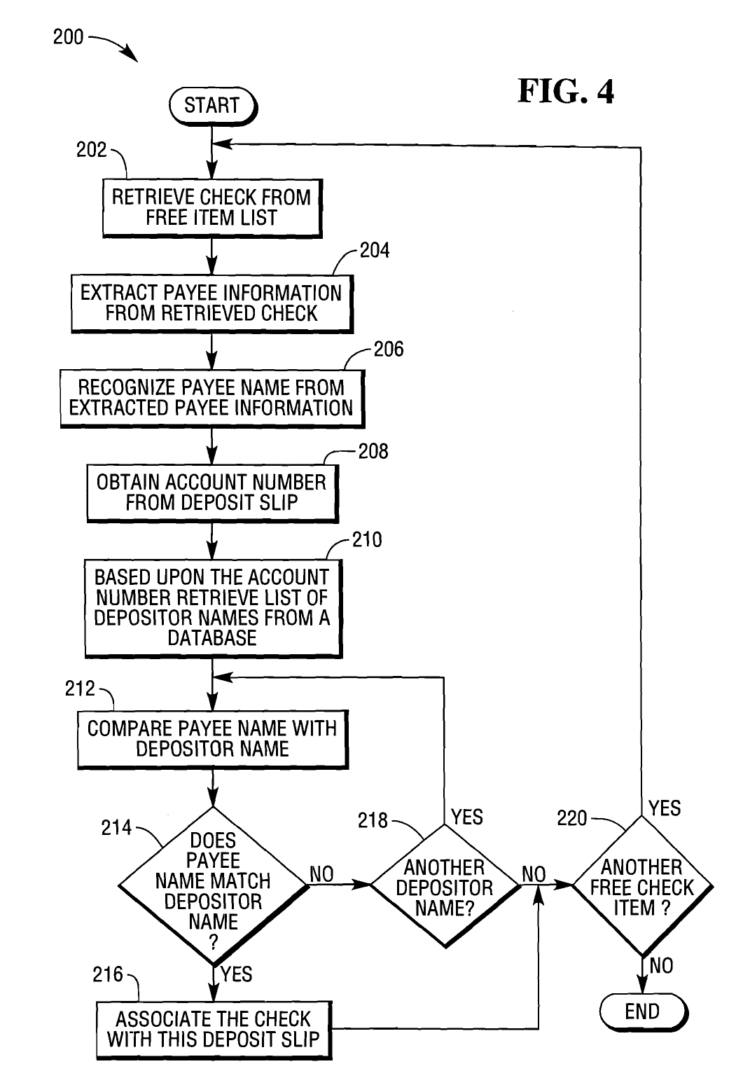

Referring to FIG. 4, a flowchart 200 depicts a process which is associated with the keying and balancing workstation 18 of FIG. 2 and which process is in accordance with one embodiment of the present invention. A free check item is obtained from the free item list stored in the third memory unit 33 (step 202). Payee information is then extracted from the retrieved free check item (step 204), and a payee name is recognized from the extracted payee information (step 206).

An account number is obtained from a deposit slip which is being processed at the keying and balancing workstation 18 (step 208). Then, based upon this account number obtained from the deposit slip, a list of depositor names is obtained from the second memory unit 32 (step 210). The payee name from step 206 is compared with the depositor names from step 210 (step 212).

A determination is made in step 214 as to whether the payee name from step 206 matches a depositor name from step 210. If the determination in step 214 is affirmative (i.e., the payee name matches the depositor name), then the process proceeds to step 216 in which this particular free check item is associated with this particular deposit slip. The process proceeds to step 220 to determine if there is another free check item from the free item list stored in the third memory unit 33 to be processed. If the determination is affirmative (i.e., there is another free check item to be processed), then the process returns back to step 202 to process this next free check item in the same manner as just described hereinabove. However, if the determination in step 220 is negative (i.e., there is no other free check item to be processed), then the process terminates.

However, if the determination back in step 214 is negative (i.e., the payee name does not match the depositor name), then the process proceeds to step 218 in which a determination is made as to whether there is another depositor name contained in the list of depositor names stored in the second memory unit 32. If the determination in step 218 is affirmative (i.e., there is another free check item to be processed), then the process proceeds back to step 212 to compare the payee name with this next depositor name in the same manner as just described hereinabove.

However, if the determination in step 218 is negative (i.e., there is no other depositor name to be compared with the payee name), then the process proceeds to step 220 to determine if there is another free check item from the free item list stored in the third memory unit 33 to be processed. If the determination is affirmative (i.e., there is another free check item to be processed), then the process returns back to step 202 to process this next free check item in the same manner as just described hereinabove. However, if the determination in step 220 is negative (i.e., there is no other free check item to be processed), then the process terminates.

While the above description describes step 216 as associating the particular free check item with the particular deposit slip, it is conceivable that the particular free check item be presented to a human operator to allow the operator to confirm if the particular free check item does indeed match the particular deposit slip before actually associating the free check item with the deposit slip.

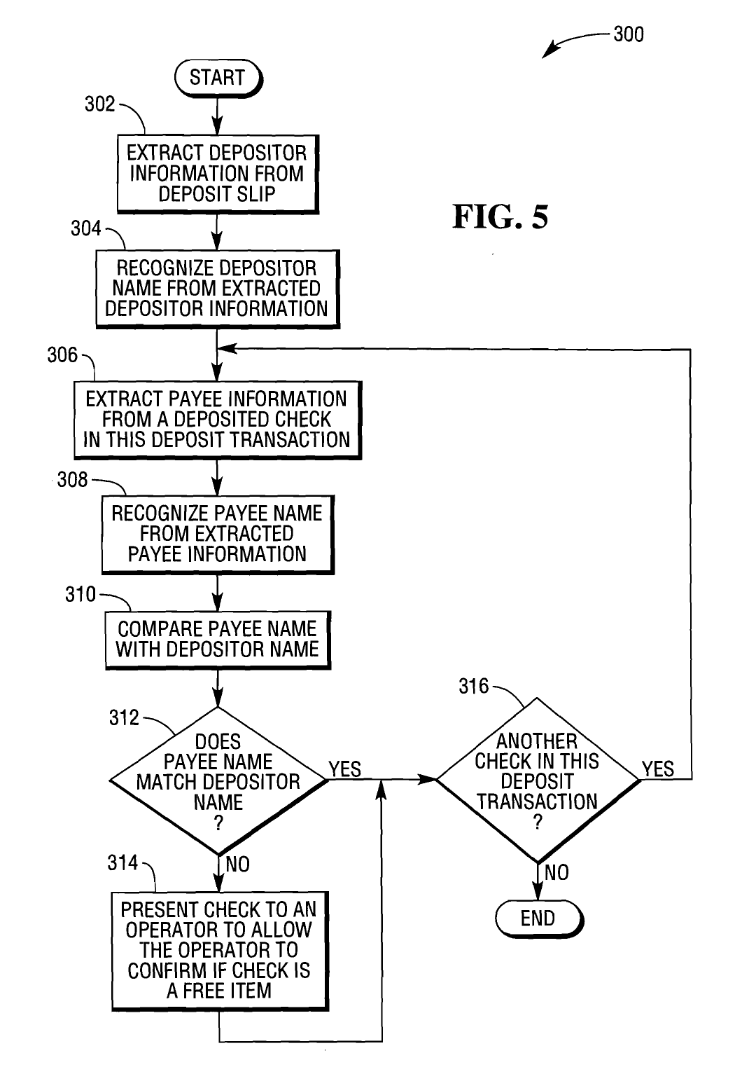

Referring to FIG. 5, a flowchart 300 depicts another process which is associated with the keying and balancing workstation 18 of FIG. 2 and which process is in accordance with another embodiment of the present invention. Depositor information is extracted from a deposit slip which is being processed at the keying and balancing workstation 18 (step 302). A depositor name is then recognized from the extracted depositor information (step 304). Payee information is extracted from a deposited check in this particular deposit transaction (step 306). A payee name is then recognized from the extracted payee information (step 308). The payee name from step 308 is compared with the depositor name from step 304 (step 310).

A determination is made in step 312 as to whether the payee name from step 308 matches the depositor name from step 304. If the determination in step 312 is affirmative (i.e., the payee name matches the depositor name), then the process proceeds to step 314 in which this particular deposited check is presented to a human operator to allow the operator to confirm if the payee name of this particular deposited check matches the depositor name of this particular deposit slip. The process proceeds to step 316 to determine if there is another check in this particular deposit transaction to be processed. If the determination in step 316 is affirmative (i.e., there is another deposited check to be processed), then the process returns back to step 306 to process this next deposited check in the same manner as just described hereinabove. However, if the determination in step 316 is negative (i.e., there is no other deposited check to be processed), then the process terminates.

However, if the determination back in step 312 is negative (i.e., the payee name does not match the depositor name), then the process proceeds directly to step 316 in which a determination is made as to whether there is another check in this particular deposit transaction to be processed. If the determination in step 316 is affirmative (i.e., there is another deposited check to be processed), then the process returns back to step 306 to process this next deposited check in the same manner as just described hereinabove. However, if the determination in step 316 is negative (i.e., there is no other deposited check to be processed), then the process terminates.

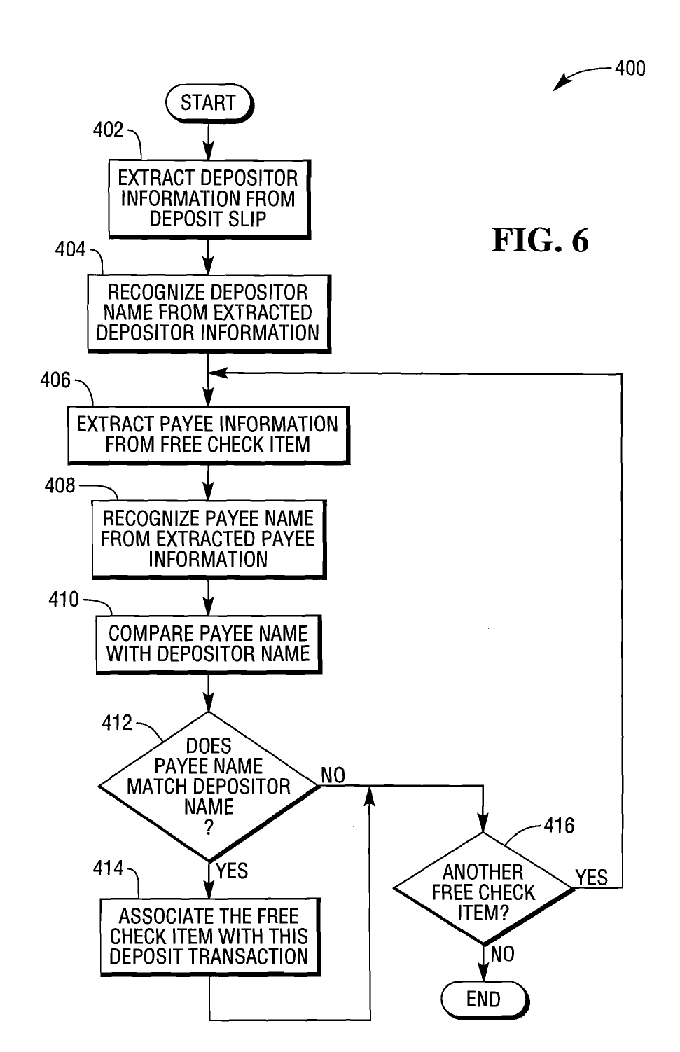

Referring to FIG. 6, a flowchart 400 depicts yet another process which is associated with the keying and balancing workstation 18 of FIG. 2 and which process is in accordance with yet another embodiment of the present invention. Depositor information is extracted from a deposit slip which is being processed at the keying and balancing workstation 18 (step 402). A depositor name is then recognized from the extracted depositor information (step 404). Payee information is extracted from a free check item from the free item list stored in the third memory unit 33. A payee name is then recognized from the extracted payee information (step 408). The payee name from step 408 is compared with the depositor name from step 404 (step 410).

A determination is made in step 412 as to whether the payee name from step 408 matches the depositor name from step 404. If the determination in step 412 is affirmative (i.e., the payee name matches the depositor name), then the process proceeds to step 414 in which this particular free check item is associated with the deposit slip of this particular deposit transaction. The process proceeds to step 416 to determine if there is another free check item in the free item list stored in the third memory unit 33. If the determination in step 416 is affirmative (i.e., there is another free check item in the free item list), then the process returns back to step 406 to process this next free check item in the same manner as just described hereinabove. However, if the determination in step 416 is negative (i.e., there is no other free check item to be processed), then the process terminates.

However, if the determination back in step 412 is negative (i.e., the payee name does not match the depositor name), then the process proceeds directly to step 416 in which a determination is made as to whether there is another free check item in the free item list to be processed. If the determination in step 416 is affirmative (i.e., there is another free check item in the free item list to be processed), then the process returns back to step 406 to process this next free check item in the same manner as just described hereinabove. However, if the determination in step 416 is negative (i.e., there is no other free check item to be processed), then the process terminates.

While the above description describes step 414 as associating the particular free check item with the particular deposit slip, it is conceivable that the particular free check item be presented to a human operator to allow the operator to confirm if the particular free check item does indeed match the particular deposit slip before actually associating the free check item with the deposit slip.

It should be apparent that above description describes a number of processes which automatically identify free check items that are missing from a deposit transaction without human operator intervention. Accordingly, the balancing function at the keying and balancing workstation 18 is made both more accurate and more efficient. The balancing function is made more accurate because out-of-balance conditions that the balancer operator might give up on are resolved. The balancing function is made more efficient because less time is required for the balancer operator to correct a situation. As an example, the number of unnecessary “missing items” adjustments is reduced.

It should also be apparent that payee recognition technology is being employed in attempt to identify free check items in a deposit transaction, and in attempt to determine the appropriate deposit for each free check item.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A computer-implemented method of operating a keying and balancing workstation of an image-based check processing system, the computer-implemented method comprising:
obtaining a free check item from a list of free check items;
extracting payee information from the free check item;
establishing a payee name from the extracted payee information;
obtaining an account number from a deposit slip;
obtaining a list of depositor names based upon the account number obtained from the deposit slip;
comparing the payee name with depositor names contained in the list of depositor names to determine if the payee name matches a depositor name; and
associating the free check item with the depositor slip when the payee name matches a depositor name from the list of depositor names.

2. A computer-implemented method according to claim 1, wherein the list of free check items is stored in a first database, and the list of depositor names is stored in a second database which is different from the first database.

3. A computer-implemented method according to claim 1, wherein the list of free check items and the list of depositor names are stored in a common database.

4. A computer-implemented method of operating a keying and balancing workstation of an image-based check processing system, the computer-implemented method comprising:
extracting depositor information from a deposit slip;
establishing a depositor name from the extracted depositor information;
extracting payee information from a deposited check;
establishing a payee name from the extracted payee information;
comparing the payee name with depositor name to determine if the payee name matches the depositor name; and
presenting the deposited check to a human operator to allow the operator to confirm if the deposited check is a free check item.

5. A computer-implemented method of operating a keying and balancing workstation of an image-based check processing system, the computer-implemented method comprising:
extracting depositor information from a deposit slip;
establishing a depositor name from the extracted depositor information;
extracting payee information from a free check item;
establishing a payee name from the extracted payee information;
comparing the payee name with depositor name to determine if the payee name matches the depositor name; and
associating the free check item with the depositor slip when the payee name matches the depositor name.
